(19) United States
(12) Patent Application Publication
(10) Pub. No.: US 2025/0258352 A1
(43) Pub. Date: Aug. 14, 2025

(54) BEND LIMITER CONFIGURED TO PREVENT A FIBER OPTIC CABLE FROM BENDING BEYOND A MINIMUM BEND RADIUS TO MITIGATE SIGNAL DEGRADATION

(71) Applicant: BELDEN CANADA ULC, Saint-Laurent (CA)

(72) Inventors: Moise LEVY, Laval (CA); Massimo P. CARBONI, Montreal (CA)

(73) Assignee: BELDEN CANADA ULC, Saint-Laurent (CA)

(21) Appl. No.: 19/050,565

(22) Filed: Feb. 11, 2025

Related U.S. Application Data
(60) Provisional application No. 63/552,492, filed on Feb. 12, 2024.

(51) Int. Cl. G02B 6/44

(52) U.S. Cl. CPC G02B 6/4461

(57) ABSTRACT

A bend limiter configured to prevent a fiber optic cable from bending beyond a minimum bend radius includes: a base that may extend in a longitudinal direction; first and second cable coupling portions at ends of the base; and a wall that may extend in a first direction perpendicular to the longitudinal direction. The wall may include segmented portions and may be configured to bend until facing surfaces of adjacent ones of the segmented portions contact one another; and the length of the base and an angle of a first notch between the adjacent segmented portions may be structurally configured to permit the wall to freely bend at any angle until the facing surfaces of the adjacent segmented portions engage one another to prevent a cable received by the cable coupling portions from bending past its minimum bend radius so as to mitigate signal degradation.

### CROSS-REFERENCE TO RELATED APPLICATION

This application claims the benefit of U.S. Provisional Patent Application No. 63/552,492, filed on Feb. 12, 2024, the disclosure of which is hereby incorporated by reference herein in its entirety.

### BACKGROUND

The present disclosure generally relates to a support and guide apparatus which facilitates the installation of a communications cable.

Improper installation of a communications cable may result in attenuation of a signal being conveyed in the cable, which is commonly known as “signal loss”. With respect to optical fiber cables, the signal loss may result from the incomplete transmission of an optical signal through the optical fiber cable. There are different reasons for losses which may occur during the transmission of optical signals through an optical fiber cable.

Also, as electronic components have become smaller and more densely packed, more electrical, optical or other forms of signal transmission cables are attached to the components. Accordingly, the components have become more difficult to organize. In addition, as the cables become more densely packed, they are subject to more stress and great probability of entanglement and damage. This situation is particularly significant for optical fiber cables. Optical fibers, for example, have a minimum bend radius. If the optical fibers are bent beyond the minimum bend radius, the fibers will be damaged. When used in this application, “cable” refers to optical fiber cables and the like.

For example, when an optical fiber cable is bent, the propagation conditions in the optical fiber cable may become altered such that light rays that would propagate in a straight optical fiber are lost in the cladding of the optical fiber. In general, bending loss may be the result of macrobending or microbending. Macrobending is the bending of the cable in a tight radius. Microbending refers to bending a small portion of the cable. Microbending may be caused by pinching or squeezing the cable and can result from mishandling or improper installation of the cable.

Nonetheless, different optical fiber cables have different specifications regarding the degree to which the cable can be bent without affecting performance of the cable or resulting in signal loss. When the bend curvature defines an angle that is too sharp for the optical signal to be reflected back into the core of the particular optical fiber, some of the optical signal may escape through the fiber cladding causing optical signal loss.

It may be desirable to provide a bend limiter configured to prevent a fiber optic cable from bending beyond a minimum bend radius so as to enhance cable performance and mitigate signal degradation.

### SUMMARY

According to various aspects of the disclosure, a bend limiter may include a base portion configured to extend in a longitudinal direction, a first cable coupling portion at a first end of the base portion, a second cable coupling portion at a second end of the base portion, a first wall portion extending between the first cable coupling portion and the second cable coupling portion, and a second wall portion extending between the first cable coupling portion and the second cable coupling portion and being spaced apart from the first wall portion. The first wall portion may include segmented portions separated from one another by a notched portion, and the second wall portion may include segmented portions separated from one another by a notched portion. The first wall portion and the second wall portion may be configured to bend until facing surfaces of adjacent segmented portions contact one another. The first and second cable coupling portions may be configured to couple with a fiber optic cable having a predetermined outer diameter, and the base portion may have a length and the notched portion forms an angle between adjacent segmented portions. The length of the based portion and the angle of the notched portion may be structurally configured to permit the first wall portion and the second wall portion to freely bend at any angle until facing wall portions the adjacent segmented portions engage one another and to prevent a cable received by the first and second cable coupling portions to bend past its minimum bend radius so as to prevent the fiber optic cable from overbending, or macrobending, thereby preventing signal loss.

A flexible cable support includes a first elongated member, a second elongated member and a base. The first elongated member (or first portion) and the second elongated member (or second portion) extend along a longitudinal axis. The base (or base portion) may connect the first elongated member and second elongated member. The first elongated member, the base, and the second elongated member define a longitudinal recess which is configured to receive a cable. The first elongated member (first portion), second elongated member (second portion) and the base (or base portion) may be integral to one another. The first and second elongated members (or first and second portions) may be flexible members.

The flexible cable support may further include a plurality of first extensions and a plurality of second extensions. The plurality of first extensions may extend from the first elongated member, and the plurality of second extensions may extend from the second elongated member. The plurality of first extensions and the plurality of second extensions may also be formed from a flexible material. The plurality of first extensions may be integral to a first upper side of the first elongated member and the plurality of second extensions may be integral to a second upper side of the second elongated member. A first and a second extensions may be configured to flex in opposing outward lateral directions as a cable is inserted into the longitudinal recess which is disposed between the first and second extensions.

The base of the flexible cable support may be defined by a plurality of lower extensions wherein each lower extension connects the first elongated member and the second elongated member. An adhesive layer may be affixed to the plurality of lower extensions. The plurality of lower extensions may be integral to a first lower surface of the first elongated member and a second lower surface of the second elongated member.

The longitudinal recess may define a first recess width and a second recess width wherein the second recess width is greater than the first recess width. The second recess width is configured to accommodate the diameter of a cable.

Each lower extension, each first extension and each lower extension include a lower region, a distal region and a middle region. The lower region may be integral to at least one of the first elongated member or the second elongated member. The distal region includes a distal end and the middle region is disposed between the distal region and the lower region. The lower region may define a first width. The distal region defines a second width at the distal end. The second width at the distal region of each extension may be greater than the first width of each extension. The middle region defines a varying width which progressively increases along an extension length towards the distal end. The second width of each lower extension, the second width of each first extension, and the second width of each second extension may, but not necessarily be equal in length. Alternatively, the second width of each lower extension, the second width of each first extension, and the second width of each second extension are equal in length while the second width of each lower extension may be greater or less than second width of each first extension and each second extension. The distal end of a first extension is configured to abut an adjacent distal end of an adjacent first extension when the first and second elongated members are bent to a maximum first predetermined angle which may be less than 180 degrees. Similarly, the distal end of a second extension may also be configured to abut an adjacent distal end of an adjacent second extension when the first and second elongated members are bent to the maximum first predetermined angle.

However, when the elongated members are bent to a maximum second predetermined angle which is greater than 180 degrees (a reflex angle), then the distal end of a lower extension is configured to abut an adjacent distal end of an adjacent lower extension when the first and second elongated members are bent to a predetermined angle which may be greater than 180 degrees.

Particular embodiments provide a bend limiter configured to prevent a fiber optic cable from bending beyond a minimum bend radius to mitigate signal degradation, including: a base portion that may be configured to extend in a longitudinal direction; a first cable coupling portion at a first end of the base portion and a second cable coupling portion at a second end of the base portion; a first wall portion that may extend between the first cable coupling portion and the second cable coupling portion, and a second wall portion that may extend between the first cable coupling portion and the second cable coupling portion and may be spaced apart from the first wall portion. The first wall portion may extend in a first direction perpendicular to the longitudinal direction; the second wall portion may extend in a second direction perpendicular to the longitudinal direction and opposite to the first direction; the first wall portion may include first segmented portions, two adjacent ones of the first segmented portions may be separated from one another by a first notched portion; the second wall portion may include second segmented portions, two adjacent ones of the second segmented portions may be separated from one another by a second notched portion; the first wall portion may be structurally configured to bend until facing surfaces of the adjacent ones of the first segmented portions contact one another; the second wall portion may be structurally configured to bend until facing surfaces of the adjacent ones of the second segmented portions contact one another; the first and second cable coupling portions may be configured to couple with a fiber optic cable having a predetermined outer diameter; the base portion may have a length, and the first notched portion may form an angle between the adjacent ones of the first segmented portions; and the length of the base portion and the angles of the notched portions may be structurally configured to permit the first wall portion and the second wall portion to freely bend at any angle until the facing surfaces of the first adjacent segmented portions or the second adjacent segmented portions engage one another to prevent a cable received by the first and second cable coupling portions from bending past its minimum bend radius so as to mitigate signal degradation.

According to various embodiments, the first wall portion may comprise two first portions.

According to various embodiments, the two first portions of the first wall portion may be parallel to each other.

According to various embodiments, the two first portions of the first wall portion may be structurally configured to receive the cable between the two first portions.

According to various embodiments, the two first portions of the first wall portion may be structurally configured to apply no force to the cable in the second direction.

According to various embodiments, the first cable coupling portion may comprise a transversely extending portion that may be structurally configured to apply a retaining force on the cable in the second direction.

According to various embodiments, the second cable coupling portion may comprise a transversely extending portion that may be structurally configured to apply a retaining force on the cable in the second direction.

According to various embodiments, the first cable coupling portion may comprise a transversely extending portion that may be structurally configured to apply a retaining force on the cable in the second direction.

According to various embodiments, the first wall portion may be structurally configured to receive the cable, and the first wall portion may be structurally configured to apply no force to the cable in the second direction.

Particular embodiments provide a bend limiter configured to prevent a fiber optic cable from bending beyond a minimum bend radius to mitigate signal degradation, including: a base portion that may be configured to extend in a longitudinal direction; a first cable coupling portion at a first end of the base portion and a second cable coupling portion at a second end of the base portion; and a first wall portion that may extend between the first cable coupling portion and the second cable coupling portion. The first wall portion may extend in a first direction that may be perpendicular to the longitudinal direction; the first wall portion may include first segmented portions, two adjacent ones of the first segmented portions may be separated from one another by a first notched portion; the first wall portion may be structurally configured to bend until facing surfaces of the adjacent ones of the first segmented portions contact one another; and the length of the base portion and an angle of the first notched portion may be structurally configured to permit the first wall portion to freely bend at any angle until the facing surfaces of the first adjacent segmented portions engage one another to prevent a cable received by the first and second cable coupling portions from bending past its minimum bend radius so as to mitigate signal degradation.

According to various embodiments, the first wall portion may comprise two first portions, and the two first portions of the first wall portion may be parallel to each other.

According to various embodiments, the two first portions of the first wall portion may be structurally configured to receive the cable between the two first portions, and may be structurally configured to apply no force to the cable in a second direction opposite to the first direction.

According to various embodiments, the first cable coupling portion may comprise a transversely extending portion that may be structurally configured to apply a retaining force on the cable in the second direction.

According to various embodiments, the second cable coupling portion may comprise a transversely extending portion that may be structurally configured to apply a retaining force on the cable in the second direction.

According to various embodiments, the first wall portion may be structurally configured to receive the cable, and the first wall portion may be structurally configured to apply no force to the cable in the second direction.

According to various embodiments, the bend limiter may further comprise a second wall portion that may extend between the first cable coupling portion and the second cable coupling portion and may be spaced apart from the first wall portion, the second wall portion may extend in a second direction perpendicular to the longitudinal direction and opposite to the first direction, the second wall portion may include second segmented portions, two adjacent ones of the second segmented portions may be separated from one another by a second notched portion, and the second wall portion may be structurally configured to bend until facing surfaces of the adjacent ones of the second segmented portions contact one another.

Particular embodiments provide a bend limiter configured to prevent a fiber optic cable from bending beyond a minimum bend radius to mitigate signal degradation, including: a base portion that may be configured to extend in a longitudinal direction; a first cable coupling portion at a first end of the base portion and a second cable coupling portion at a second end of the base portion; and a first wall portion that may be configured to extend in a first direction perpendicular to the longitudinal direction. The first wall portion may include first segmented portions; the first wall portion may be structurally configured to bend until facing surfaces of adjacent ones of the first segmented portions contact one another; and the length of the base portion and an angle of a first notched portion between the first adjacent segmented portions may be structurally configured to permit the first wall portion to freely bend at any angle until the facing surfaces of the first adjacent segmented portions engage one another to prevent a cable received by the first and second cable coupling portions from bending past its minimum bend radius so as to mitigate signal degradation.

According to various embodiments, the first wall portion may comprise two first portions, and the two first portions of the first wall portion may be parallel to each other, the two first portions of the first wall portion may be structurally configured to receive the cable between the two first portions, and may be structurally configured to apply no force to the cable in a second direction opposite to the first direction.

According to various embodiments, the first cable coupling portion may comprise a transversely extending portion that may be structurally configured to apply a retaining force on the cable in the second direction.

According to various embodiments, the second cable coupling portion may comprise a transversely extending portion that may be structurally configured to apply a retaining force on the cable in the second direction.

Various aspects of the bend limiter, as well as other embodiments, objects, features and advantages of this disclosure, will be apparent from the following detailed description of illustrative embodiments thereof, which is to be read in conjunction with the accompanying drawings.

### BRIEF DESCRIPTION OF THE DRAWINGS

Further advantages and features of the present disclosure will become apparent from the following description and the accompanying drawings, to which reference is made. In which are shown:

FIG. 1A is an isometric view of a first non-limiting example flexible cable support according to the present disclosure wherein a cable is disposed in the flexible cable support.

FIG. 1B is an isometric view of the flexible cable support in FIG. 1A which illustrates an example longitudinal recess wherein the cable is removed from the flexible cable support.

FIG. 2 is a partial, side view of the flexible cable support of FIG. 1A.

FIG. 3 is a cross-sectional view of the flexible cable support and cable along line 3-3 in FIG. 2.

FIG. 4 is a plan view of the flexible cable support and cable in FIG. 1A.

FIG. 5A is a side view of the flexible cable support of FIG. 1A without the cable.

FIG. 5B is a side view of the flexible cable support where flexible cable support is bent to a predetermined angle which exceeds 180 degrees.

FIG. 5C is a side view of the flexible cable support where flexible cable support is bent to a predetermined angle which is less than 180 degrees.

FIG. 6A is a side view of the flexible cable support and cable in FIG. 1A installed on an inner surface of a corner frame wherein the flexible cable support is bent to an angle which is less than 180 degrees.

FIG. 6B is a side view of the flexible cable support and cable in FIG. 1A installed on an outer surface of a corner frame wherein the flexible cable support is bent to an angle which is greater than 180 degrees.

FIG. 7 is a perspective view of a first bend limiting portion of a bend limiter in accordance with various aspects of the disclosure.

FIG. 8 is a perspective view of the first bend limiting portion of FIG. 7 coupled with a fiber optic cable and attached to an inside bend surface.

FIG. 9 is a perspective view of a second bend limiting portion of a bend limiter in accordance with various aspects of the disclosure.

FIG. 10 is a perspective view of the second bend limiting portion of FIG. 9 coupled with a fiber optic cable and attached to an outside bend surface.

FIG. 11 is a perspective view of the second bend limiting portion of FIG. 9 coupled with a fiber optic cable.

### DETAILED DESCRIPTION OF EMBODIMENTS

Reference will now be made in detail to presently preferred embodiments and methods of the present disclosure, which constitute the best modes of practicing the present disclosure presently known to the inventors. The figures are not necessarily to scale. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

As used in the specification and the appended claims, the singular form “a,” “an,” and “the” comprise plural referents unless the context clearly indicates otherwise. For example, reference to a component in the singular is intended to comprise a plurality of components.

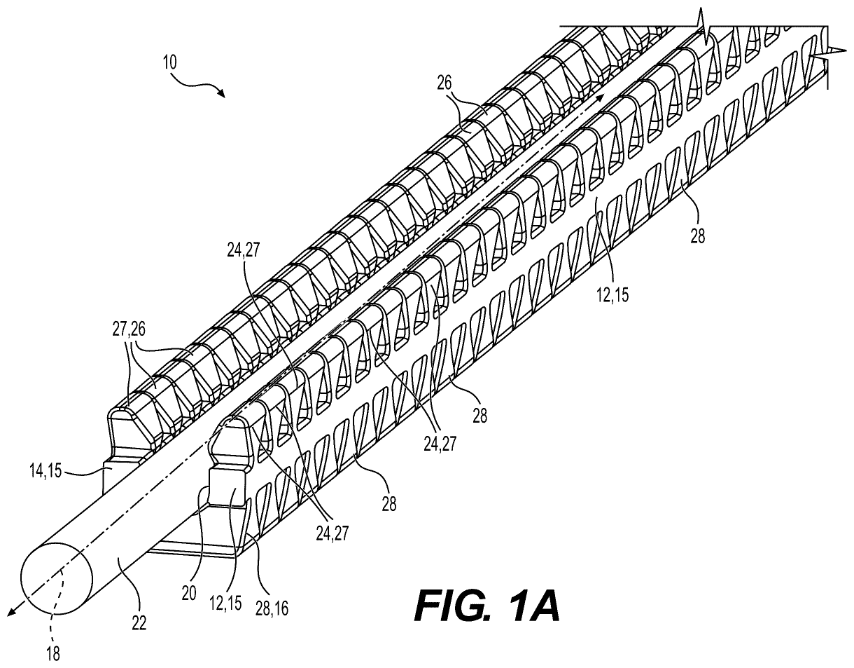

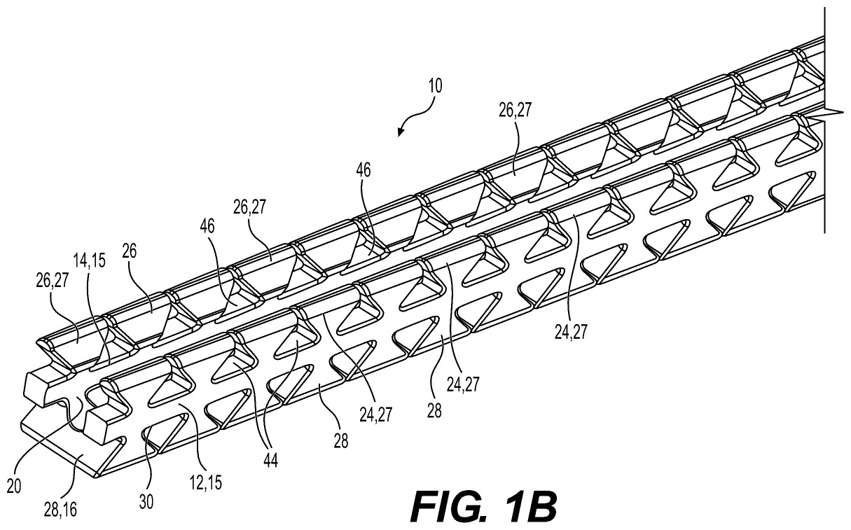

As shown in FIG. 1, an isometric view of a first non-limiting example flexible cable support 10 according to the present disclosure wherein a cable 22 is disposed in the flexible cable support 10. The flexible cable support 10 shown in FIG. 1 may, but not necessarily, be an integrated flexible member formed from a polymeric material. The flexible cable support 10 is configured to support and guide a cable 22 in a variety of ways as shown in the non-limiting examples described herein.

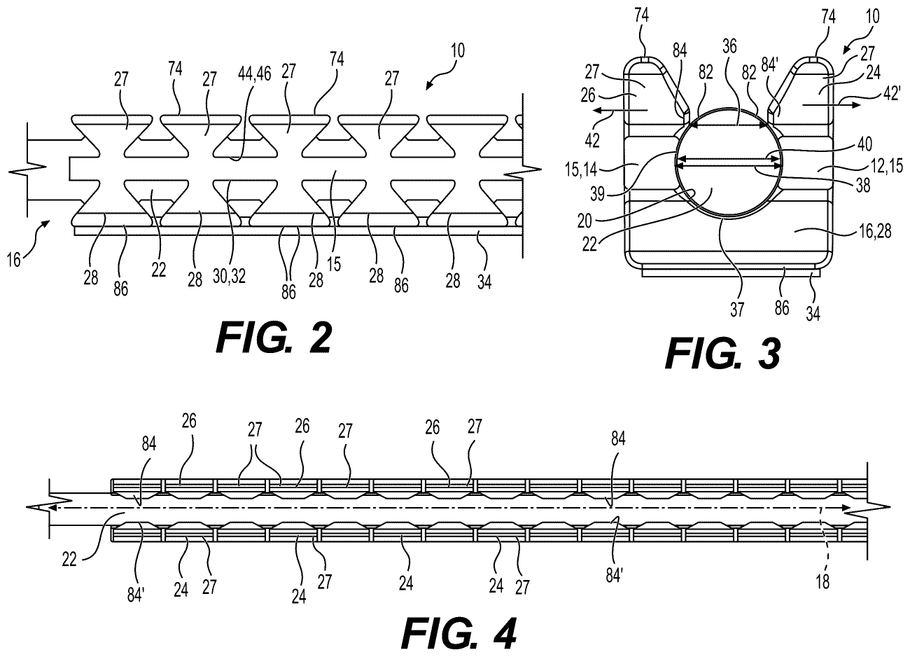

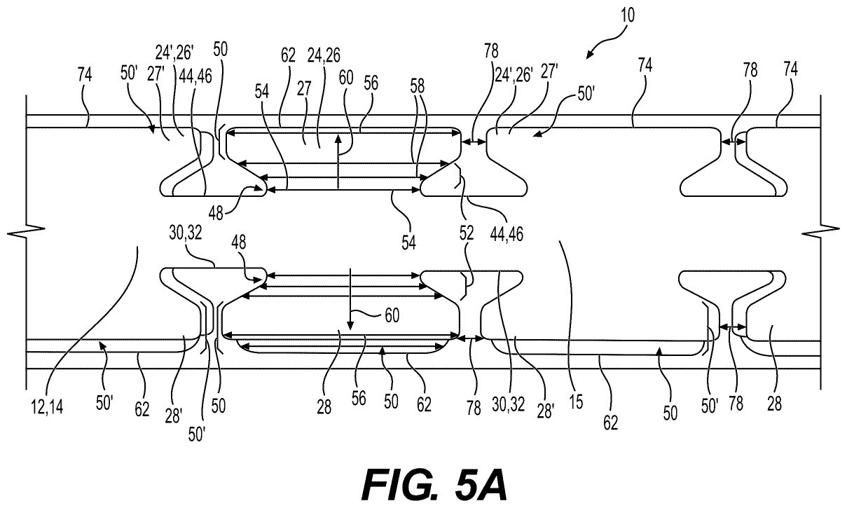

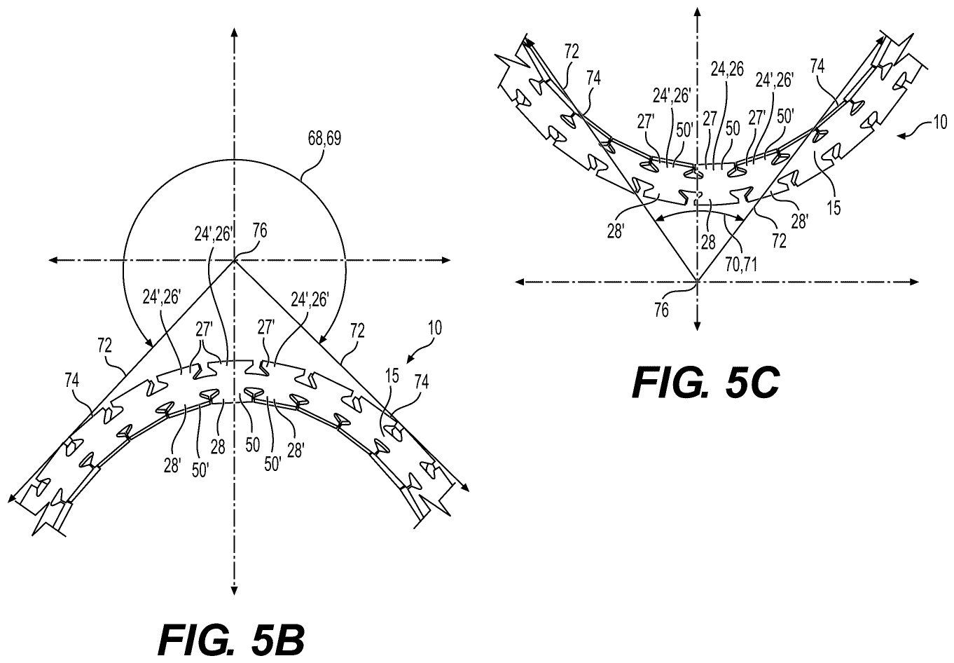

Referring now to FIGS. 1-3, the flexible cable support 10 includes a first elongated member 12 (or first portion 12), a second elongated member 14 (or second portion 14), and a base 16 wherein the first elongated member 12 (first portion 12), second elongated member 14 (second portion 14) and the base 16 define a longitudinal recess 20. The first elongated member 12 (first portion 12) and the second elongated member 14 (second portion 14) may both be elongated flexible members as shown in FIGS. 1-2 wherein the first elongated member 12 and the second elongated member 14 extend along a longitudinal axis 18 as shown in FIG. 1. As shown in FIGS. 5B and 5C, the first elongated member 12 (first portion 12) and the second elongated member 14 (second portion 14) are at least configured to bend according to a reflex angle 68 (FIG. 5B) as later described herein, an acute angle (FIG. 5C) as later described herein and configured to be disposed in a flat orientation or 180 degrees (FIG. 1).

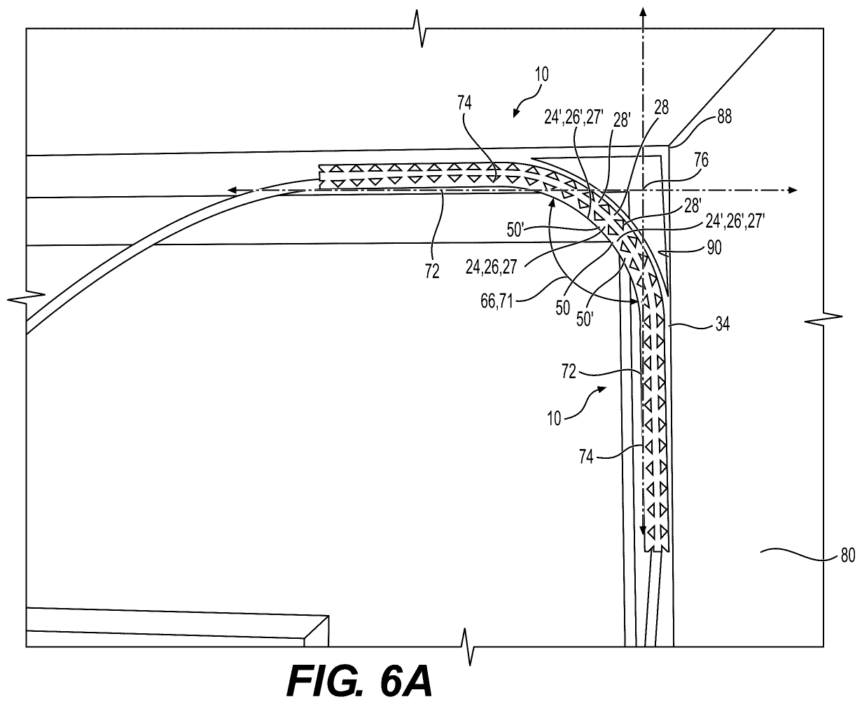

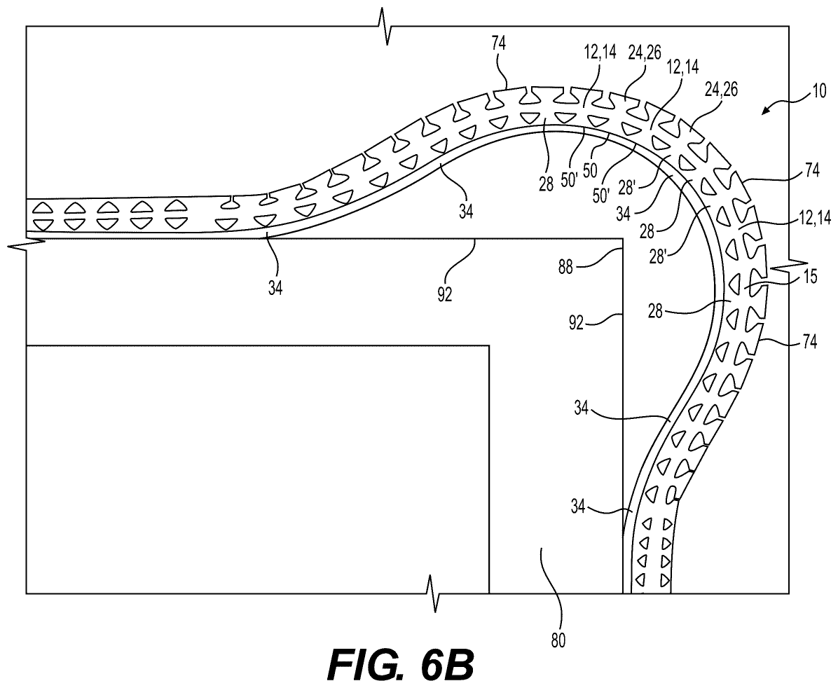

The flexible cable support 10 may also optionally include an adhesive layer 34 as shown in FIGS. 6A, 6B wherein the adhesive layer 34 may be affixed to the base 16 of the cable support 10. A single adhesive layer 34 may be affixed to the outer surface 86 of the base 16 (FIG. 3) along the length of the base 16 in a longitudinal direction or the adhesive layer 34 may be intermittently affixed to the outer surface 86 of the base 16 so that only portions of the outer surface 86 of the base 16 have an adhesive layer 34. The adhesive layer 34 is configured to affix the cable support 10 (and associated cable 22) to a structure 80 in a particular fashion as later described herein. Alternative to the optional adhesive layer 34, the flexible cable support 10 may also optionally include a fastener and a tab (not shown) wherein the tab is configured to receive the fastener. The tab may be coupled to (or integral to) the first elongated member 12 (first portion 12) or the second elongated member 14 (second portion 14) or both. The longitudinal recess 20 is configured to receive the cable 22.

As shown in FIG. 3, the base 16 may define the lower region 37 of the longitudinal recess 20. Both the first elongated member 12 (first portion 12) and the second elongated member 14 (second portion 14) define at least the middle region 39 of the longitudinal recess 20. As shown in the plan view provided in FIG. 4, the longitudinal recess 20 is accessible from the top of the flexible cable support 10 to enable insertion of the cable 22 into the longitudinal recess 20. As shown in FIG. 2, the longitudinal recess 20 defines a first recess width 36 and a second recess width 38 wherein the second recess width 38 is greater than the first recess width 36. The second recess width 38 is configured to accommodate the full diameter 40 of a cable 22. The first recess width 36 is less than both the full diameter 40 of the cable 22 and the second recess width 38. However, it is understood that at least the first elongated member 12 (first portion 12) and the second elongated member 14 (second portion 14) are flexible members which are configured to flex in opposing outward lateral directions 42, 42′ (see FIG. 3) as the cable 22 is inserted into the longitudinal recess 20. Similarly, it is understood that the plurality of first and second extensions 24, 26 may also be configured to flex in opposing outward lateral directions 42, 42′ as the cable 22 is inserted into the longitudinal recess 20. Upon exerting a force onto the cable 22 so as to install the cable 22 into the longitudinal recess 20 of the cable support 10, the first and second elongated members 12, 14 and/or the first and second extensions 24, 26 (which are proximate to the region of cable 22 being inserted) are urged in opposing outward lateral directions 42, 42′. Therefore, upon inserting the cable 22 into the flexible cable support 10, the first recess width 36 (FIG. 3) may temporarily increase due to the flexion of the cable support 10 and to accommodate the full diameter of the cable as described above. Once the cable 22 is fully seated in the longitudinal recess 20 as shown in FIGS. 2-3, the upper side regions 84, 84′ of the longitudinal recess 20 abut portions of the upper surface 82 of the cable 22 to maintain the cable 22 in position within the longitudinal recess 20 of the flexible cable support 10.

Referring again to FIG. 1B, a plurality of first extensions 24 may extend from a first upper side 46 of the first elongated member 12 (or first portion 12) and a plurality of second extensions 26 may extend from a second upper side 44 of the second elongated member 14 (or second portion 14). In the example shown in FIGS. 1A-4, the plurality of first extensions 24 may, but not necessarily be integral to a first upper side 44 of the first elongated member 12 (first portion 12). Similarly, the plurality of second extensions 26 may, but not necessarily, be integral to a second upper side 46 of the second elongated member 14 (second portion 14). As shown in FIG. 3, the plurality of first extensions 24 and the plurality of second extensions 26 may be flexible such that they may flex in opposing, outward/lateral directions 42, 42′ (see FIG. 3) upon insertion of the cable 22 as previously described.

Referring to FIGS. 1-3, the base 16 is defined by a plurality of lower extensions 28. As shown in FIGS. 1B and 3, each lower extension connects the first elongated member 12 (first portion 12) to the second elongated member 14 (second portion 14). The plurality of lower extensions 28 may, but not necessarily, be integral to a first lower side of the first elongated member 12 (first portion 12) and a second lower side 32 of the second elongated member 14 (second portion 14). The adhesive layer 34 (shown as element 34 in FIG. 3) may optionally be affixed to the outer surface 86 (FIGS. 2-3) of the plurality of lower extensions 28. It is understood that the first elongated member 12 (first portion 12), second elongated member 14 (second portion 14), and the base 16 may, but not necessarily, be integral to one another. The first elongated member 12 (first portion 12), second elongated member 14 (second portion 14), and base 16 may but not necessarily be formed via an injection molding process, and may even be formed via a dual shot injection molding process in the event the first elongated member 12 (first portion 12), second elongated member 14 (second portion 14), and the base 16 must have different elasticity characteristics (varying modulus of elasticity). However, it is also understood that the first elongated member 12 (first portion 12), second elongated member 14 (second portion 14) and the base 16 may also be separate components.

As shown in FIG. 5A, an enlarged partial view of an exemplary side of the cable support 10 is shown without the adhesive layer 34. It is understood that in this example embodiment the first extension 24 and the second extension 26 have the same side profile. Therefore, the side views (first side view showing the first elongated member 12 and the second side view showing the second elongated member 14) of the example cable support 10 are the same regardless of whether the first side view is shown or the second side view is shown. Regardless, as shown in the side view in FIG. 2 (which may illustrate either the first side view showing the first elongated member 12 (first portion 12) or the second side view showing second elongated member 14 (second portion 14)), the extension 27 (first extension 24 or second extension 26) includes a lower region 48 which is integral to its corresponding elongated member 15 (first elongated member 12 or second elongated member 14). Therefore, the plurality of first extensions 24 are integral to the first elongated member 12 (first portion 12) while the plurality of second extensions 26 are integral to the second elongated member 14 (second portion 14).

As shown in FIGS. 1A-1B, the plurality of first extensions 24 may span along the length of the first elongated member 12 (first portion 12) and the plurality of second extensions 26 may span along the length of the second elongated member 14 (second portion 14). It is understood that extension 27 as used in the present disclosure is intended to generically reference a first extension 24 and/or a second extension 26. Similarly, it is also understood that elongated member 15 (or portion 15) as used in the present disclosure is intended to generically reference the first elongated member 12 and/or the second elongated member 14.

Referring to FIG. 5A, each extension 27 (first extension 24 or second extension 26) includes a distal region 50 having a distal end 62 as well as a middle region 52 disposed between the distal region 50 and the lower region 48. As shown in FIG. 5A, the lower region 48 of each extension 27 (first extension 24 or second extension) defines a first width 54 which is adjacent to the corresponding elongated member 15 (or portion 15) which may be either the first elongated member 12 or second elongated member 14. The distal region 50 defines a second width 56 at the distal end 62 of the extension 15. The second width 56 is greater than the first width 54. However, as shown in FIG. 5A, the middle region 52 may, but not necessarily define a varying width 58 which progressively increases along the length 60 of the extension (“extension length 60”) towards the distal end 62.

With reference to the plurality of lower extensions 28, the plurality of lower extensions 28 connect the first elongated member 12 (first portion 12) to the second elongated member 14 (second portion 14) as previously indicated. (See FIG. 1A & 3). Similarly, the plurality of the lower extensions 28 may span the length of both the first and second elongated members 12, 14. However, as shown in FIGS. 1A-1B and 5A, it is also understood that each lower extension 28 also includes a distal region 50 having a distal end 62 as well as a middle region 52 disposed between the distal region 50 and the lower region 48. As shown in FIG. 5A, the lower region 48 of each lower extension 28 defines a first width 54 which is adjacent to both the first elongated member 12 (first portion 12) and the second elongated member 14 (second portion 14) and the distal region 50 of the lower extension 28 also defines a second width 56 in the distal region 50 of the lower extension 28. The second width 56 is greater than the first width 54. However, as shown in FIG. 5A, the middle region 52 of each lower extension 28 may, but not necessarily define a varying width 58 which progressively increases along the length 60 of the extension (“extension length 60) towards the distal end 62. It is understood that the second width 56 of each first extension 24 may be equal in length to the second width 56 of each second extension 26 to enable uniform flexion of the cable 10 if desired. It is also understood that the second width 56 of each lower extension 28 may, but not necessarily, be equal in length to the second width 56 of each first extension 24 and may, but not necessarily, also be equal in length to the second width 56 of each second extension 26 such that each first extension 24, each second extension 26 and each lower extension 28 have the same second width 56 length.

Referring now to FIGS. 5B-5C, FIG. 5B is a side view of the flexible cable support 10 where flexible cable support 10 is bent to a maximum second predetermined reflex angle 69 which exceeds 180 degrees, and FIG. 5C is a side view of the flexible cable support 10 where flexible cable support 10 is bent to a predetermined non-reflex angle 71 or a maximum first predetermined angle 71 which is less than 180 degrees. With respect to the various examples of the present disclosure, it is understood that the tangent lines 72 of the top surface 74 (from the center of rotation 76) define a flexion angle 66 which may be a reflex angle 68 (greater than 180 degrees) or a non-reflex angle 70 (less than 180 degrees). It is understood that the cable support is not bent (as shown in FIGS. 1A-1B) when the angle 66 between the tangent lines 72 is 180 degrees. In FIG. 5B, the tangent lines 72 of the top surface 74 (from the center of rotation 76) form a reflex angle 68 wherein the flexible cable support 10 is bent all the way to a maximum predetermined reflex angle 69 wherein at least one lower extension 28 abuts the adjacent lower extensions 28′. At this predetermined reflex angle 69, the distal region 50 of a lower extension 28 in the plurality of lower extensions 28 is configured to abut the adjacent distal regions 50′ of the adjacent lower extensions 28′ when the first and second elongated members 12, 14 are bent to the predetermined reflex angle 69. As shown, it is also understood that the distal region 50 of the lower extension 28 may abut the adjacent distal regions 50′ of the adjacent lower extensions 28′ disposed on each side of the lower extension 28.

Accordingly, the abutment between the distal regions of the lower extensions 28, 28′ as shown during such flexion prevents macrobending of the cable 22 and therefore, prevents unnecessary damage to the cable 22 during the installation process. Noting that certain cables 22 may have certain bending limits, it is understood that the maximum, predetermined reflex angle 69 is set during the design process according to the length of the second width 56 of each lower extension 28. Therefore, as the second width 56 of each lower extension 28 is increased (during the design process), the maximum predetermined reflex angle 69 would be decreased. Accordingly, as the second width 56 of each lower extension 28 increases during the design process, the gap 78 (shown in FIG. 5A) may decrease. Thus, the maximum, predetermined reflex angle 69 would decrease. The gap 78 is evident when the flexible cable support 10 is straight as shown in FIG. 5A. Similarly, as the second width 56 of each lower extension 28 is decreased (during the design process), the predetermined reflex angle 69 would be increased and the gap 78 (evident in FIG. 5A where the cable support 10 is straight) would also increase to enable the increased predetermined reflex angle 69.

Noting that the flexion angle 66 may be any angle, the example of FIG. 5C shows a flexion angle 66 which is less 180 degrees (“non-reflex angle 70”). Therefore, the flexion angle of FIG. 5C is a non-reflex angle 70. The tangent lines 72 of the top surface 74 (from the center of rotation 76) form an acute angle wherein the flexible cable support 10 is bent all the way to a maximum, predetermined non-reflex angle 71. It is understood that the “non-reflex angle 70” may be an acute angle or an obtuse angle.

In FIG. 5C showing a flexion angle 66 which is less than 180 degrees, the tangent lines 72 of the top surface 74 (from the center of rotation 76) form a flexion angle 66 where the flexible cable support 10 is bent all the way to a predetermined non-reflex angle 71. At this predetermined non-reflex angle 71, the distal region 50 of a first extension 24 in the plurality of first extensions 24 is configured to abut the adjacent distal regions 50′ of the adjacent first extensions 24′ when the first and second elongated members 12, 14 are bent all the way to the maximum predetermined non-reflex angle 71.

In the example provided in FIG. 5C, each first extension 24 and each second extension 26 define a second width 56 having equal lengths. It is understood that the cable support 10 of the present disclosure may, but not necessarily, provide first extensions 24 which are aligned with second extensions 26 (as shown in FIGS. 1, 3, 5A-5C) to enable (optional) uniform flexion of the cable support 10 if desired. Therefore, FIGS. 5A-5C side views are identical regardless of whether the first elongated member 12 (first portion 12) and first extensions 24 are shown or whether the second elongated member 14 (second portion 14) and second extensions 26 are shown. Nonetheless, referring again to FIGS. 5C, a distal region 50 of a second extension 26 in the plurality of second extensions 26 is configured to abut the adjacent distal regions 50′ of the adjacent second extensions 26′ when the first and second elongated members 12, 14 are bent to the predetermined non-reflex angle 71.

Referring now to FIG. 6A, a side view of the flexible cable support 10 and cable 22 in FIG. 1 installed onto an inner surface 80 of a corner frame 80 (or structure 80) wherein the flexible cable support 10 is bent all the way to an example predetermined non-reflex angle 71 which is set at 90 degrees. Therefore, each extension in the plurality of first and second extensions 24, 26 is configured to abut an adjacent distal end 62′ of an adjacent extension when the first and second elongated members 12, 14 are bent to the predetermined non-reflex angle 71. In the region proximate to the corner of the frame, the abutment between distal regions 50, 50′ of the adjacent extensions 15 (from either the first elongated member 12 (first portion 12) and/or second elongated member 14 (second portion 14)) prevents the possibility of the cable 22 being subjected to macrobending such that the optical fibers could be damaged as the cable 22 is routed proximate to the corner 88 shown. It is understood that only the distal end 62 of each first extension 24 and each second extension 26 may, but not necessarily formed by a rigid material (for example, by a dual shot injection molded process) such that little to no compression could occur as the adjacent distal end 62's abut each other. Alternatively, the distal end 62 of each first extension 24 and each second extension 26 may, but not necessarily formed by flexible material (such as but not limited to the same material implemented in the first elongated member 12 (first portion 12) and second elongated member 14 (second portion 14)) wherein some compression could occur at each distal end 62 as the adjacent distal end 62's abut each other. In the example of FIG. 6A, the adhesive layer 34 attaches the cable support 10 (and the accompanying cable 22) to an inner corner of a frame. However, it is understood that the adhesive layer 34 of the cable support 10 may also attach the cable support 10 (and the accompanying cable 22) to yet another cable support 10 (and its accompanying cable 22) should portions of multiple lines be routed in close proximity to one another.

Referring now to FIG. 6B, the flexible cable support 10 and cable 22 in FIG. 1A is installed on an outside surface 92 of a corner frame 80 (or structure 80) wherein the flexible cable support 10 is bent to a reflex angle 68 which is greater than 180 degrees. Therefore, a distal region 50 of a lower extension 28 is configured to abut the adjacent distal regions 50′ of the adjacent lower extensions 28′ when the first and second elongated members 12, 14 are bent all the way to the maximum predetermined reflex angle 69. In the region proximate to the corner 88 of the frame 80, the abutment between the (distal regions 50, 50′ of) adjacent lower extensions 28, 28′ prevents the possibility of the cable 22 from being subjected to macrobending (to prevent damage to optical fibers) as the cable 22 is routed proximate to the outside corner 88 shown. It is understood that only the distal region 50 of each extension 24, 26, 28 may, but not necessarily formed by a relatively rigid material (for example, by a dual shot injection molded process) such that little to no compression could occur as the adjacent distal end 62's abut each other. Alternatively, the distal region 50 of each first extension 24 and each second extension 26 may, but not necessarily, be formed by flexible material (such as but not limited to the same material implemented in the first elongated member 12 (first portion 12) and second elongated member 14 (second portion 14)) wherein some compression could occur at each distal end 62 as the adjacent distal end 62's abut each other.

In the example of FIG. 6B, the adhesive layer 34 attaches the cable support 10 (and the accompanying cable 22) to an outer surface 92 of a frame 80. However, as indicated above, it is understood that the adhesive layer 34 of the cable support 10 may also attach the cable support 10 (and the accompanying cable 22) to yet another cable support 10 (and its accompanying cable 22) should portions of multiple lines be routed in close proximity to one another.

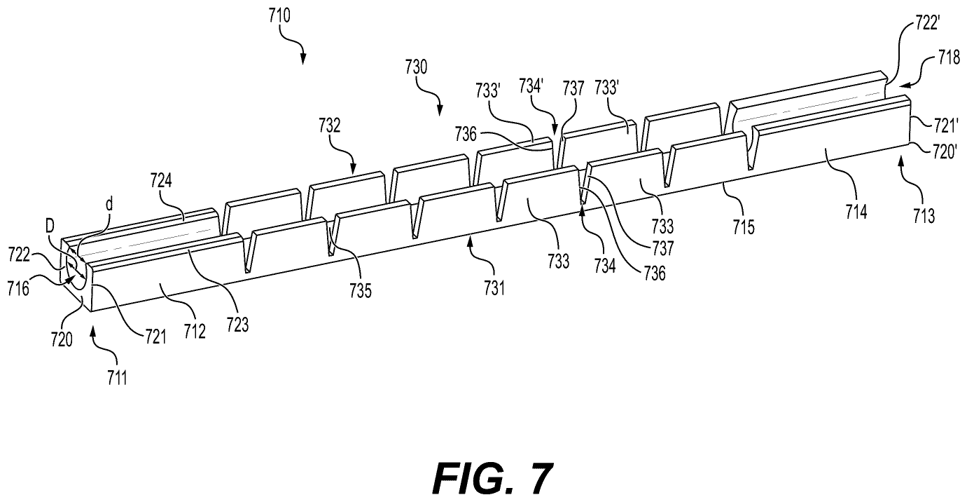

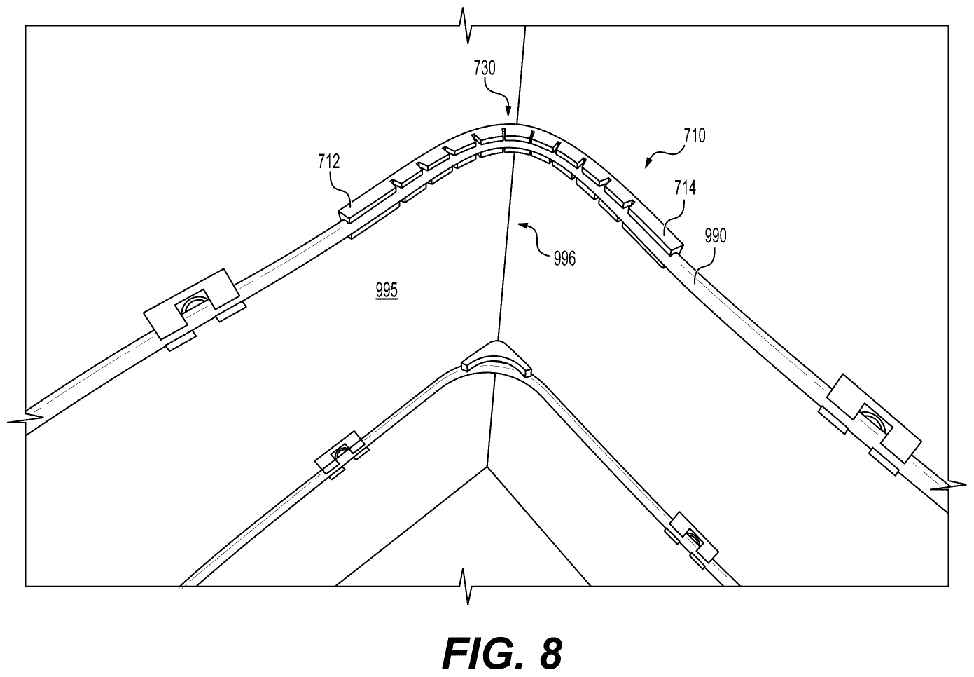

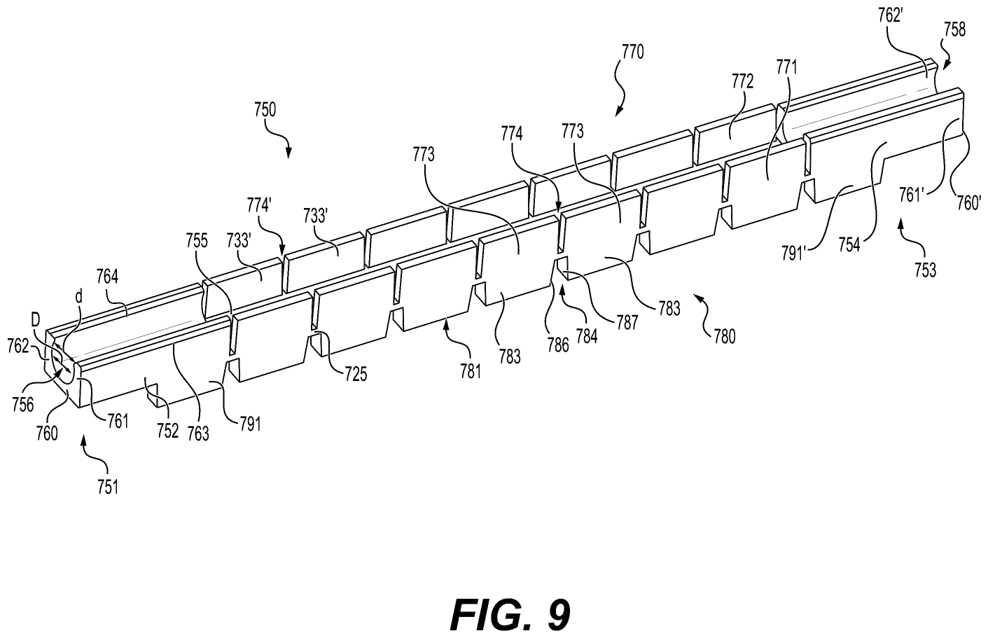

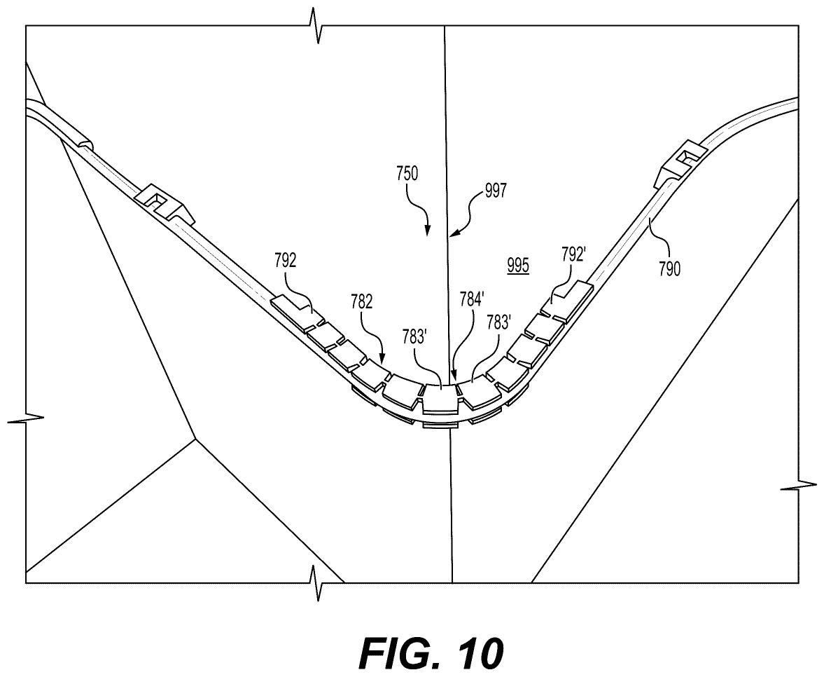

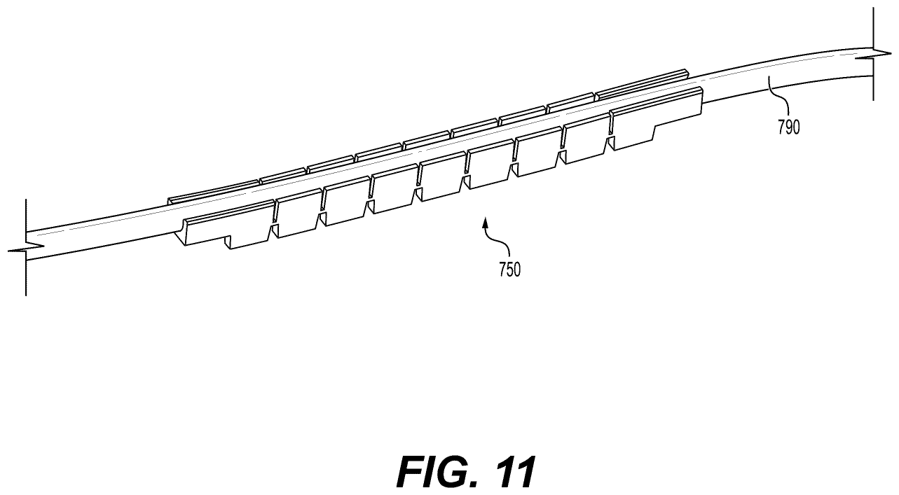

Referring now to FIGS. 7-11, another embodiment of a bend limiter configured to prevent a fiber optic cable from bending beyond a minimum bend radius is disclosed. The embodiment of FIGS. 7-11 includes a first bend limiting portion 710 configured to prevent a fiber optic cable from bending beyond a minimum bend radius at an inside corner, as illustrated in FIGS. 7 and 8, and/or a second bend limiting portion 750 configured to prevent a fiber optic cable from bending beyond a minimum bend radius at an outside corner, as illustrated in FIGS. 9 and 10.

As shown in FIGS. 7 and 8, the first bend limiting portion 710 includes a first cable coupling portion 712 at a first end 711 and a second cable coupling portion 714 at a second end 713. For example, the first and second cable coupling portions 712, 714 may comprise clips. That is, the first and second cable coupling portions 712, 714 may including a cable receiving portion 716, 718 configured to receive a cable, for example, a fiber optic cable 990. The first cable coupling portion 712 may include a base portion 720 and two extension portions 721, 722 extending from the base portion 720. The extension portions 721, 722 each include a free end portion 723, 724, and the free end portions, for example, transversely extending portions, 723, 724 are spaced apart from one another by a distance d that is less than an inner diameter D of the cable receiving portion 716. The extension portions 721, 722 comprise a material that permits the extension portions 721, 722 to be urged apart from one another to permit a cable having an outer diameter greater than the distance d to be inserted through the space between the free end portions 723, 724 and into the cable receiving portion 716. The second cable coupling portion 714 includes a cable receiving portion 718, a base portion 720′, and two extension portions 721′, 722′ extending from the base portion 720′. The second cable coupling portion 714 is configured the same as the first cable coupling portion 712, but further details are not particularly identified for clarity purposes.

The first bend limiting portion 710 includes a cable retaining portion 730 between the first and second cable coupling portions 712, 714. The cable retaining portion 730 includes a base portion 735, and a first wall portion 731 and a second wall portion 732 extending from the base portion 735. The first wall portion 731 extends between the first extension portions 721, 721′, and the second wall portion 732 extends between the second extension portions 722, 722′. As illustrated, the first wall portion 731 includes a plurality of segmented portions 733 separated by a notched portion 734. Similarly, the second wall portion 732 includes a plurality of segmented portions 733′ separated by a notched portion 734′. The first wall portion 731 and the second wall portion 732 are configured to retain a fiber optic cable 990 therebetween, while permitting the fiber optic cable 990 to move in a direction away from the base portion 735. The first wall portion 731 and the second wall portion 732 have a reduced frictional relationship with a fiber optic cable 990 as compared with the first and second cable coupling portions 712, 714 such that the first bend limiting portion 710 can be more easily slid along the fiber optic cable 990.

As shown in FIG. 8, the first and second wall portions 731, 732 are configured to permit the first bend limiting portion 710 to freely bend at any angle until facing wall portions 736, 737 of adjacent segmented portions 733 engage one another. It should be understood that the angles and sizes of the notched portions 734, 734′ are substantially the same and are selected based on a minimum bend radius of a fiber optic cable 990 that is to be received in the cable receiving portions 716, 716′. That is, the angles and sizes of the notched portions 734, 734′ are selected such that the facing wall portions 736, 737 of adjacent segmented portions 733 engage one another at or before the fiber optic cable 990 reaches its minimum bend radius so as to prevent the fiber optic cable 990 from overbending, or macrobending, which could cause signal loss.

The base portions 720, 720′ of the first and second cable coupling portions 712, 714 and the base portion 735 of the cable retaining portion 730 comprise a planar surface portion 715 opposite to the extension portions 721, 721′, 722, 722′ and the first and second wall portions 731, 732. The planar surface portion 715 is configured to be mounted with a wall surface 995 so as to provide a low profile of a fiber optic cable 990 and the first bend limiting portion 710 relative to the wall surface 995, even at an inside bend 996 of the wall surface 995. Of course, the first bend limiting portion 710 comprises a material that permits the aforementioned bending.

As shown in FIGS. 9-11, the second bend limiting portion 750 includes a first cable coupling portion 752 at a first end 751 and a second cable coupling portion 754 at a second end 753. For example, the first and second cable coupling portions 752, 754 may comprise clips. That is, the first and second cable coupling portions 752, 754 may including a cable receiving portion 756, 758 configured to receive a cable, for example, a fiber optic cable 990. The first cable coupling portion 752 may include a base portion 760 and two extension portions 761, 762 extending from the base portion 760. The extension portions 761, 762 each include a free end portion 763, 764, and the free end portions 763, 764 are spaced apart from one another by a distance d that is less than an inner diameter D of the cable receiving portion 756. The extension portions 761, 762 comprise a material that permits the extension portions 761, 762 to be urged apart from one another to permit a cable having an outer diameter greater than the distance d to be inserted through the space between the free end portions 763, 764 and into the cable receiving portion 756. The second cable coupling portion 754 includes a cable receiving portion 758, a base portion 760′, and two extension portions 761′, 762′ extending from the base portion 760′. The second cable coupling portion 754 is configured the same as the first cable coupling portion 752, but further details are not particularly identified for clarity purposes.

The second bend limiting portion 750 includes a cable retaining portion 770 between the first and second cable coupling portions 752, 754. The cable retaining portion 770 includes a base portion 775, and a first wall portion 771 and a second wall portion 772 extending from the base portion 775 in a first direction. The first wall portion 771 extends between the first extension portions 761, 761′, and the second wall portion 772 extends between the second extension portions 762, 762′. As illustrated, the first wall portion 771 includes a plurality of segmented portions 773 separated by a notched portion 774. Similarly, the second wall portion 772 includes a plurality of segmented portions 773′ separated by a notched portion 774′. The first wall portion 771 and the second wall portion 772 are configured to retain a fiber optic cable 990 therebetween, while permitting the fiber optic cable 990 to move in a direction away from the base portion 775. The first wall portion 771 and the second wall portion 772 have a reduced frictional relationship with a fiber optic cable 990 as compared with the first and second cable coupling portions 752, 754 such that the second bend limiting portion 750 can be more easily slid along the fiber optic cable 990.

The second bend limiting portion 750 includes a surface engaging portion 780 at least partially between the first and second cable coupling portions 752, 754. The surface engaging portion 780 includes a first wall portion 781 and a second wall portion 782 (FIG. 10) extending from the base portion 775 in a second direction that is opposite to the first direction. The first wall portion 781 extends between first extension portions 791, 791′ (which extend from the first cable coupling portion 752 and the second cable coupling portion 754).The second wall portion 782 extends between second extension portions 792, 792′ (FIG. 10) (which extend from the first cable coupling portion 752 and the second cable coupling portion 754. As illustrated, the first wall portion 781 includes a plurality of segmented portions 783 separated by a notched portion 784. Similarly, the second wall portion 782 includes a plurality of segmented portions 783′ separated by a notched portion 784′ (FIG. 10).

As shown in FIG. 10, the first and second wall portions 781, 782 are configured to permit the first bend limiting portion 750 to freely bend at any angle until facing wall portions 786, 787 of adjacent segmented portions 783 engage one another. It should be understood that the angles and sizes of the notched portions 784, 784′ are substantially the same and are selected based on a minimum bend radius of a fiber optic cable 990 that is to be received in the cable receiving portions 756, 758. That is, the angles and sizes of the notched portions 784, 784′ are selected such that the facing wall portions 786, 787 of adjacent segmented portions 783 engage one another at or before the fiber optic cable 990 reaches its minimum bend radius so as to prevent the fiber optic cable 990 from overbending, or macrobending, which could cause signal loss.

In exemplary embodiments of first bend limiting portion 710, the notched portions 734, 734′ create a gap between adjacent facing wall portions 736, 736′, 737, 737′ that form an angle in the range of, for example, 10-18 degrees, and in some embodiments 14 degrees, when the first bend limiting portion 710 is at rest in an unbent state. In exemplary embodiments, the total bend radius of the first bend limiting portion 710 is between, for example, 80 and 130 degrees, and in some embodiments, 112 degrees (8 notched portions 734, 734′ at 14 degrees each). In exemplary embodiments, the segmented portions 733, 733′ have a length in the longitudinal direction of, for example, between 5 and 8 mm, and in some embodiments 6.4 mm. In exemplary embodiments, the wall portions 731, 732 have a height of, for example, between 3 and 6 mm, and in some embodiments 4.25 mm. In exemplary embodiments, the inner diameter D of the cable receiving portion 716 is between, for example, 2 and 6 mm, and in some examples, 4 mm. In exemplary embodiments, the width of the first bend limiting portion 710 is between, for example, 4 and 8 mm, and in some embodiments, 6 mm. In exemplary embodiments, the length of the first bend limiting portion 710 is between, for example, 60 and 90 mm, and in some embodiments, 80 mm.

In exemplary embodiments of second bend limiting portion 750, the notched portions 784, 784′ create a gap between adjacent facing wall portions 786, 787 that form an angle in the range of, for example, 10-18 degrees, and in some embodiments 14 degrees, when the second bend limiting portion 750 is at rest in an unbent state. In exemplary embodiments, the total bend radius of the second bend limiting portion 750 is between, for example, 80 and 130 degrees, and in some embodiments, 112 degrees (8 notched portions 784, 784′ at 14 degrees each). In exemplary embodiments, the segmented portions 773, 773′, 783, 783′ have a length in the longitudinal direction of, for example, between 5 and 8 mm, and in some embodiments 6.4 mm. In exemplary embodiments, the notched portions 774, 774′ create a gap between adjacent facing wall portions of segmented portions 733, 733′ of, for example, between 0.5 and 2 mm, and in some embodiments, 1 mm when the second bend limiting portion 750 is at rest in an unbent state. In exemplary embodiments, the wall portions 773, 773′ have a height of, for example, between 3 and 6 mm, and in some embodiments 4.25 mm. In exemplary embodiments, the wall portions 783, 783′ have a height of, for example, between 2 and 4 mm, and in some embodiments 2.5 mm. In exemplary embodiments, the inner diameter D of the cable receiving portion 716 is between, for example, 2 and 6 mm, and in some examples, 4 mm. In exemplary embodiments, the width of the second bend limiting portion 750 is between, for example, 4 and 8 mm, and in some embodiments, 6 mm. In exemplary embodiments, the length of the second bend limiting portion 750 is between, for example, 60 and 100 mm, and in some embodiments, 90 mm.

The second bend limiting portion 750 comprises a material that permits the aforementioned bending. The second bend limiting portion 750 is configured to be mounted with a wall surface 995 so as to provide a low profile of a fiber optic cable 990 and the second bend limiting portion 750 relative to the wall surface 995, even at an outside bend 997 of the wall surface 995.

While various example, non-limiting embodiments have been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A bend limiter configured to prevent a fiber optic cable from bending beyond a minimum bend radius to mitigate signal degradation, comprising:
a base portion configured to extend in a longitudinal direction;
a first cable coupling portion at a first end of the base portion and a second cable coupling portion at a second end of the base portion;
a first wall portion extending between the first cable coupling portion and the second cable coupling portion, and a second wall portion extending between the first cable coupling portion and the second cable coupling portion and being spaced apart from the first wall portion;
wherein the first wall portion extends in a first direction perpendicular to the longitudinal direction;
wherein the second wall portion extends in a second direction perpendicular to the longitudinal direction and opposite to the first direction;
wherein the first wall portion includes first segmented portions, two adjacent ones of the first segmented portions being separated from one another by a first notched portion;
wherein the second wall portion includes second segmented portions, two adjacent ones of the second segmented portions being separated from one another by a second notched portion;
wherein the first wall portion is structurally configured to bend until facing surfaces of the adjacent ones of the first segmented portions contact one another;
wherein the second wall portion is structurally configured to bend until facing surfaces of the adjacent ones of the second segmented portions contact one another;
wherein the first and second cable coupling portions are configured to couple with a fiber optic cable having a predetermined outer diameter;
wherein the base portion has a length, and the first notched portion forms an angle between the adjacent ones of the first segmented portions; and
wherein the length of the base portion and the angles of the notched portions are structurally configured to permit the first wall portion and the second wall portion to freely bend at any angle until the facing surfaces of the first adjacent segmented portions or the second adjacent segmented portions engage one another to prevent a cable received by the first and second cable coupling portions from bending past its minimum bend radius so as to mitigate signal degradation.

2. The bend limiter of claim 1, wherein the first wall portion comprises two first portions.

3. The bend limiter of claim 2, wherein the two first portions of the first wall portion are parallel to each other.

4. The bend limiter of claim 2, wherein the two first portions of the first wall portion are structurally configured to receive the cable between the two first portions.

5. The bend limiter of claim 4, wherein the two first portions of the first wall portion are structurally configured to apply no force to the cable in the second direction.

6. The bend limiter of claim 5, wherein the first cable coupling portion comprises a transversely extending portion that is structurally configured to apply a retaining force on the cable in the second direction.

7. The bend limiter of claim 6, wherein the second cable coupling portion comprises a transversely extending portion that is structurally configured to apply a retaining force on the cable in the second direction.

8. The bend limiter of claim 1, wherein the first cable coupling portion comprises a transversely extending portion that is structurally configured to apply a retaining force on the cable in the second direction.

9. The bend limiter of claim 1, wherein the first wall portion is structurally configured to receive the cable, and the first wall portion is structurally configured to apply no force to the cable in the second direction.

10. A bend limiter configured to prevent a fiber optic cable from bending beyond a minimum bend radius to mitigate signal degradation, comprising:
a base portion configured to extend in a longitudinal direction;
a first cable coupling portion at a first end of the base portion and a second cable coupling portion at a second end of the base portion;
a first wall portion extending between the first cable coupling portion and the second cable coupling portion;
wherein the first wall portion extends in a first direction perpendicular to the longitudinal direction;
wherein the first wall portion includes first segmented portions, two adjacent ones of the first segmented portions being separated from one another by a first notched portion;
wherein the first wall portion is structurally configured to bend until facing surfaces of the adjacent ones of the first segmented portions contact one another; and
wherein the length of the base portion and an angle of the first notched portion are structurally configured to permit the first wall portion to freely bend at any angle until the facing surfaces of the first adjacent segmented portions engage one another to prevent a cable received by the first and second cable coupling portions from bending past its minimum bend radius so as to mitigate signal degradation.

11. The bend limiter of claim 10, wherein the first wall portion comprises two first portions, and the two first portions of the first wall portion are parallel to each other.

12. The bend limiter of claim 11, wherein the two first portions of the first wall portion are structurally configured to receive the cable between the two first portions, and are structurally configured to apply no force to the cable in a second direction opposite to the first direction.

13. The bend limiter of claim 12, wherein the first cable coupling portion comprises a transversely extending portion that is structurally configured to apply a retaining force on the cable in the second direction.

14. The bend limiter of claim 13, wherein the second cable coupling portion comprises a transversely extending portion that is structurally configured to apply a retaining force on the cable in the second direction.

15. The bend limiter of claim 10, wherein the first cable coupling portion comprises a transversely extending portion that is structurally configured to apply a retaining force on the cable in a second direction opposite to the first direction.

16. The bend limiter of claim 10, wherein the first wall portion is structurally configured to receive the cable, and the first wall portion is structurally configured to apply no force to the cable in the second direction.

17. The bend limiter of claim 11, wherein the bend limiter further comprises a second wall portion extending between the first cable coupling portion and the second cable coupling portion and being spaced apart from the first wall portion,
the second wall portion extends in a second direction perpendicular to the longitudinal direction and opposite to the first direction,
the second wall portion includes second segmented portions, two adjacent ones of the second segmented portions being separated from one another by a second notched portion, and
the second wall portion is structurally configured to bend until facing surfaces of the adjacent ones of the second segmented portions contact one another.

18. A bend limiter configured to prevent a fiber optic cable from bending beyond a minimum bend radius to mitigate signal degradation, comprising:
a base portion configured to extend in a longitudinal direction;
a first cable coupling portion at a first end of the base portion and a second cable coupling portion at a second end of the base portion;
a first wall portion configured to extend in a first direction perpendicular to the longitudinal direction;
wherein the first wall portion includes first segmented portions;
wherein the first wall portion is structurally configured to bend until facing surfaces of adjacent ones of the first segmented portions contact one another; and
wherein the length of the base portion and an angle of a first notched portion between the first adjacent segmented portions are structurally configured to permit the first wall portion to freely bend at any angle until the facing surfaces of the first adjacent segmented portions engage one another to prevent a cable received by the first and second cable coupling portions from bending past its minimum bend radius so as to mitigate signal degradation.

19. The bend limiter of claim 18, wherein the first wall portion comprises two first portions, and the two first portions of the first wall portion are parallel to each other, the two first portions of the first wall portion are structurally configured to receive the cable between the two first portions, and are structurally configured to apply no force to the cable in a second direction opposite to the first direction.

20. The bend limiter of claim 19, wherein the first cable coupling portion comprises a transversely extending portion that is structurally configured to apply a retaining force on the cable in the second direction.

21. The bend limiter of claim 20, wherein the second cable coupling portion comprises a transversely extending portion that is structurally configured to apply a retaining force on the cable in the second direction.
